(19) United States
(12) Patent Application Publication
(10) Pub. No.: US 2016/0026004 A1
(43) Pub. Date: Jan. 28, 2016

(54) EYEWEAR HAVING MAGNETIC CLIP-ON LENSES

(71) Applicant: Brent SHELDON, Montreal (CA)

(72) Inventors: Brent SHELDON, Montreal (CA); Robert KATZ, Montreal (CA); Sylvain DUCHESNE, Bromont (CA)

(21) Appl. No.: 14/495,974

(22) Filed: Sep. 25, 2014

Related U.S. Application Data
(63) Continuation-in-part of application No. 14/338,919, filed on Jul. 23, 2014.

(51) Int. Cl. G02C 7/08

(52) U.S. Cl. CPC G02C 7/086; G02C 2202/02

(57) ABSTRACT

Eyewear according to one embodiment includes a primary frame retaining at least one primary lens, and a clip-on lens assembly having a secondary frame removably attachable to the front of the primary frame by magnetic forces interacting between two magnets affixed to the primary frame and the clip-on lens assembly, respectively. The attachment is achieved between a convex outer surface and a concave inner surface of the respective primary and secondary frames. The clip-on lens assembly includes a positioning member affixed to the secondary frame of the clip-on lens assembly for positioning the clip-on lens assembly with respect to the primary frame.

### CROSS REFERENCE TO RELATED APPLICATIONS

The present invention is a continuation-in-part of co-pending application Ser. No. 14/338,919 filed on Jul. 23, 2014.

### TECHNICAL FIELD

The described subject matter relates generally to an improvement on a structure of eyewear and, more particularly, to a structure of eyewear having clip-on lenses.

### BACKGROUND OF THE ART

Secondary lens assemblies which can be removably attached to the front of conventional eyewear, are popularly used to convert conventional eyewear to sunglasses. Among various designs magnets have been used for attaching secondary lens assemblies to conventional eyewear. For example, a conventional eyewear frame may include a magnetic material secured around the peripheral portion, facilitating attachment of a second lens assembly to the conventional eyewear frame, such as described in U.S. Pat. No. 4,070,103 of Meeker, or the magnets may be secured to the temporal portions of a conventional frame that mate with similar magnets in a secondary lens assembly, such as described in U.S. Pat. No. 5,416,537 of Sadler. Those magnets are embedded in portions of the eyewear frames in a vertical orientation for mating with similarly positioned magnets in the secondary lens assembly. These secondary lens assemblies are therefore held in place in front of the conventional eyewear frame only by the magnetic forces and are not supported to prevent the secondary lens assemblies from moving vertically relative to the conventional eyewear frames, which may allow unexpected detachment of the secondary lens assemblies from the conventional eyewear frames. Efforts have been made and continue to be made to address this problem.

There is a need to develop an improved design for eyewear with attachable secondary lens assemblies to overcome the shortcomings of the conventional designs thereof.

### SUMMARY

In one aspect, there is provided eyewear comprising: a primary frame retaining at least one primary lens, the primary frame having an upper part extending between opposed side ends of the primary frame and a support device being operatively attached to the respective opposed side ends of the primary frame for supporting the eyewear on a user's head, and a first magnet attached to a first central section of the upper part, the first central section having a convex outer surface projecting away from the user's head; and a secondary lens assembly removably attachable to a front of the primary frame, the secondary lens assembly including: a secondary frame retaining at least one secondary lens, the secondary frame having an upper part extending between opposed side ends of the secondary frame, a second central section of the upper part of the secondary frame defining a concave inner surface and including a second magnet to allow the second central section of the upper part of the secondary frame to be removably attached to the first central section of the upper part of the primary frame by magnetic forces interacting between the first and second magnets, the concave inner surface of the second central section of the upper part of the secondary frame mating with the convex outer surface of the first central section of the upper part of the primary frame.

In another aspect, there is provided eyewear comprising: a primary frame having opposed side ends and including primary left and right sections retaining a pair of primary lenses, respectively, a first nose bridge being disposed between and interconnecting the primary left and right sections, a support device being operatively attached to the respective opposed side ends of the primary frame for supporting the eyeglasses on a user's head, the first nose bridge including a first magnet and defining a convex outer surface projecting away from the user's head; and a secondary lens assembly removably attached to a front of the primary frame, the secondary lens assembly including: a secondary frame including secondary left and right sections retaining a pair of secondary lenses, respectively, a second nose bridge being disposed between and interconnecting the secondary left and right sections, the second nose bridge defining a concave inner surface and including a second magnet to allow the second nose bridge to be removably attached to the first nose bridge of the primary frame by magnetic forces interacting between the first and second magnets, the concave inner surface of the second nose bridge mating the convex outer surface of the first nose bridge; and a positioning member affixed to the second nose bridge of the secondary frame, projecting over and being in contact with the first nose bridge such that the first and second magnets are placed within a magnetic interaction area between the first and second magnets, the first magnet being positioned lower than the second magnet.

### DESCRIPTION OF THE DRAWINGS

Reference is now made to the accompanying drawings, showing by way of illustration the described embodiments thereof in which:

FIG. 1 is an isometric view of eyewear with a clip-on lens assembly according to one embodiment;

FIG. 2 is a rear isometric view of the eyewear of FIG. 1 with the clip-on lens assembly removed, showing the back side of the primary frame structure;

FIG. 3 is a front isometric view of the primary structure of FIG. 2;

FIG. 4 is a top plan view of the clip-on lens assembly of FIG. 1;

FIG. 5 is a rear isometric view of the clip-on lens assembly of FIG. 4;

FIG. 6 is a partial cross-sectional view taken along line 6-6 of FIG. 1, showing attachment of the clip-on lens assembly to the primary frame of the eyewear;

FIG. 7 is a rear isometric view of the eyewear of FIG. 1 with the clip-on lens assembly moved upwardly to be detached from the primary frame of the eyewear;

FIG. 8 is a front elevational view of eyewear with click-on lens assembly according to another embodiment;

FIG. 9 is a cross-sectional view of the eyewear taken along line 9-9 in FIG. 8;

FIG. 10 is an enlarged partial cross-sectional view of a circled area A of the eyewear of FIG. 9, showing the attachment of the clip-on lens assembly to a primary frame of the eyewear;

FIG. 11 is a partial cross-sectional view of the eyewear taken along line 11-11 in FIG. 8;

FIG. 12 is a top plan view of the clip-on lens assembly of the eyewear of FIG. 9;

FIG. 13 is an isometric view of the clip-on lens assembly of FIG. 12;

FIG. 14 is a front elevational view of a magnet used in the eyewear of FIG. 9; and

FIG. 15 is a top plan view of the magnet of FIG. 14.

It will be noted that throughout the appended drawings, like features are identified by like reference numerals.

### DETAILED DESCRIPTION

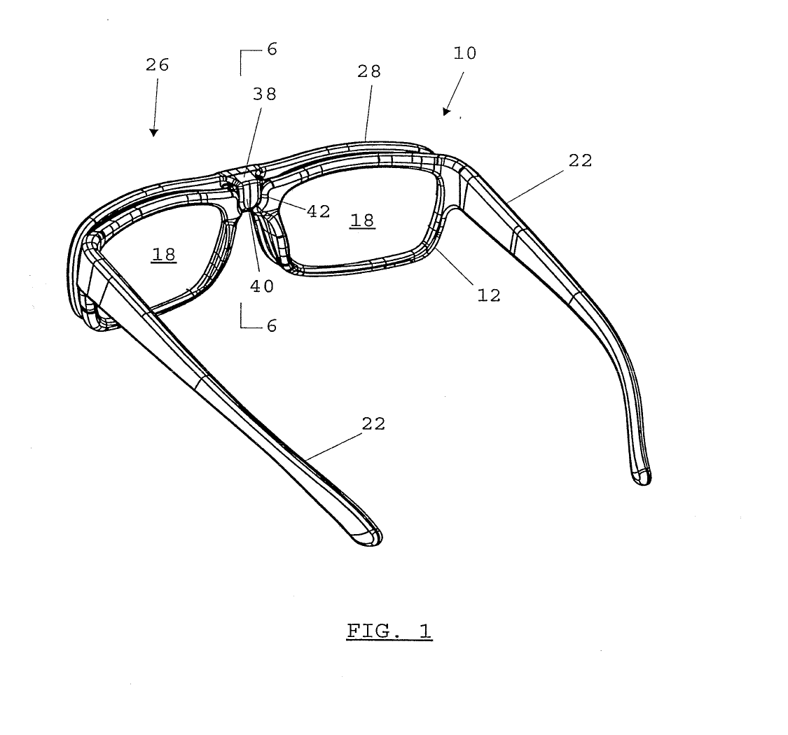

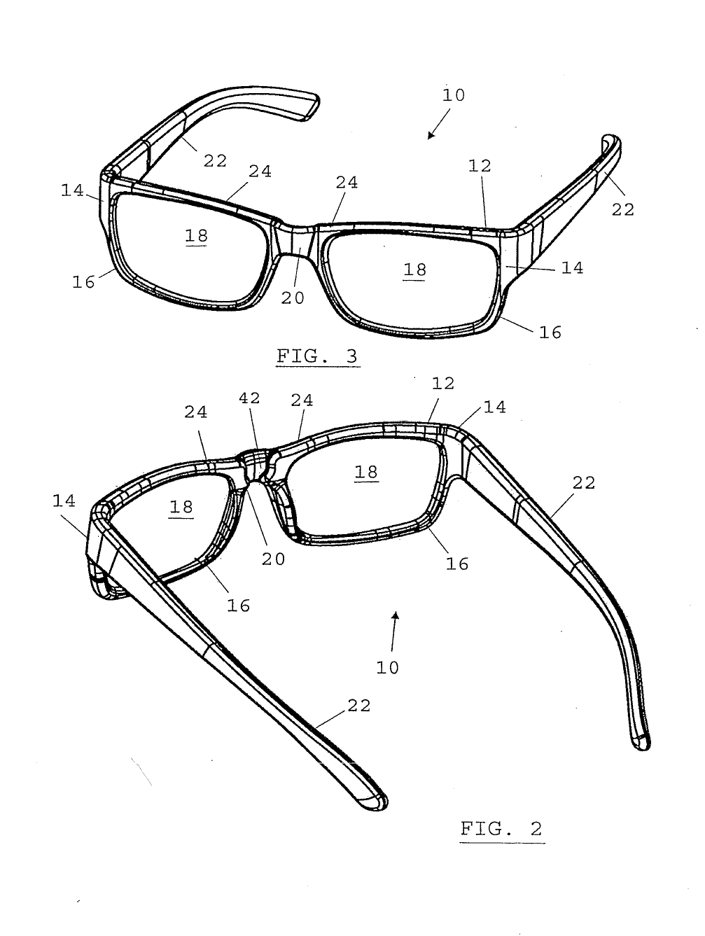

Referring to FIGS. 1-3, eyewear 10 according to one embodiment, generally includes a primary frame 12 which for example may be made of a rigid plastic material in a molding process, having opposed side ends 14 for retaining at least one primary lens. In this embodiment the primary frame 12 includes primary left and right sections 16 for retaining a pair of primary lenses 18, respectively. A nose bridge 20 is disposed between and interconnects the primary left and right sections 16 of the primary frame 12. A support device, for example a pair of temples 22, may be pivotally attached to the respective opposed side ends 14 of the primary frame 12 for supporting the eyewear 10 on a user's head. It should be noted that the nose bridge 20 may be made out of a semi-rigid flexible material and connected to the rest of the frame 12 adhesively or by mechanical engagement or otherwise contemplated by someone skilled in the art.

The primary left and right sections 16 of the primary frame 12 according to one embodiment, may be configured as an endless rim surrounding each primary lens 18. Alternatively, the primary left and right sections 16 of the primary frame 12 may be configured to have only an upper part 24 of the rims which engages only an upper section of a peripheral edge of the respective primary lenses 18.

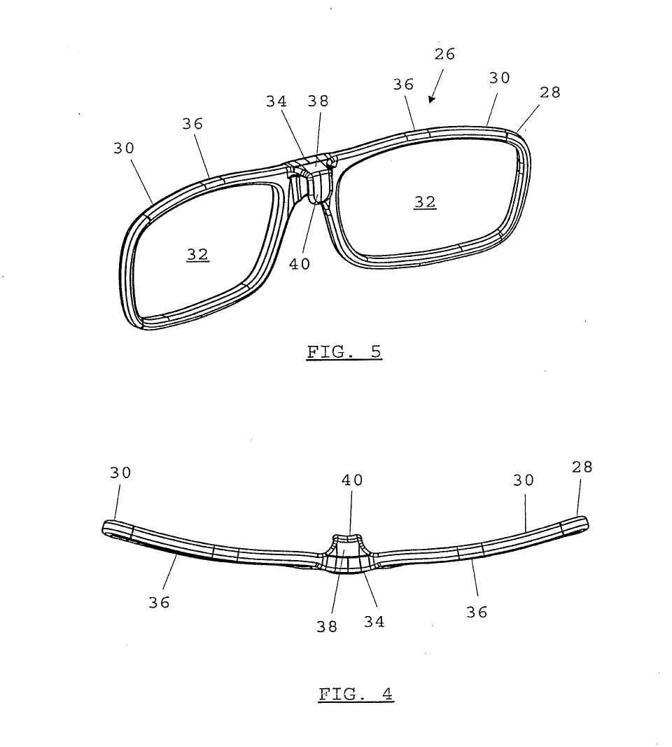

Referring to FIGS. 1, 4 and 5, a clip-on lens assembly 26 (secondary lens assembly) according to one embodiment, may include a secondary frame 28 retaining at least one secondary lens. In this embodiment the secondary frame 28 may include secondary left and right sections 30 thereof for retaining a pair of secondary lenses 32, respectively, which, for example may be tinted for protecting a user's eyes from the sun. A nose bridge 34 may be disposed between and interconnect the secondary left and right sections 30 of the secondary frame 28.

The secondary left and right sections 30 of the secondary frame 28 may be configured in an endless rim configuration, corresponding with the primary left and right sections 16 of the primary frame 12. Alternatively, the secondary left and right sections of the secondary frame 28 may also be configured to have only an upper part 36 which engages only with a corresponding upper section of a peripheral edge of the respective secondary lenses 32.

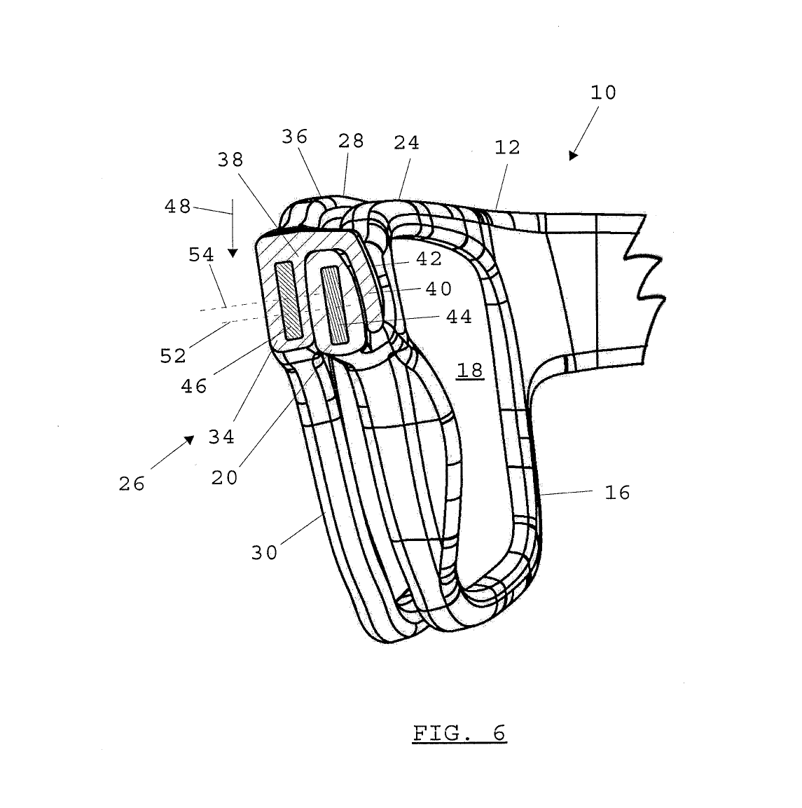

Referring to FIGS. 1-7, the clip-on lens assembly 26 according to one embodiment, may include a connector 38 affixed to a central location of an upper part of the secondary frame 28, such as the nose bridge 34. The connector 38 may include a hook (not numbered) and the primary frame 12 may have a recess 42 at a central location of the primary frame 12, for example in the nose bridge 20 at a back side of the nose bridge 34 facing a user's face. The hook of the connector 38 may be slidable downwardly relative to the recess 42, to engage with the recess 42 for positioning the clip-on lens assembly 26 with respect to the primary frame 12. When the clip-on lens assembly 26 is positioned in place as shown in FIG. 6, the clip-on lens assembly 26 is removably secured to the front of the primary frame 12 by magnetic forces interacting between a first magnet 44 affixed for example to the nose bridge 20 of the primary frame 12, and a second magnet 46 affixed for example to the connector 38 of the secondary frame 28.

The connector 38 according to one embodiment, may be integrated with the nose bridge 34 of the secondary frame 28 and in combination with the nose bridge 34, may be configured in an inverted U-shaped configuration to form such a hook. For example, the inverted U-shaped configuration connector 38 may be formed with the nose bridge 34 in a molding process of the secondary frame 28 when the secondary frame 28 is made of a plastic material. The nose bridge 20 of the primary frame 12 may slide upward into the inverted U-shaped configuration of the connector 38, when the connector 38 is engaged with the recess 42 of the primary frame 12. The recess 42 may be defined at a back side of the nose bridge 20 of the primary frame 12, for receiving a positioning member 40 (see FIGS. 1 and 4-7 (one leg of the inverted U-shaped configuration of the connector 38), which may slide downwardly into the recess 42. The recess 42 may have a shape complementary to the shape of the positioning member 40 (the leg of the inverted U-shaped configuration of the connector 38) allowing accurate positioning of the clip on lens assembly 26 in front of the primary frame 12. Therefore, the positioning member 40 when fitted within the recess 42, may position the clip-on lens assembly 26 such that the nose bridge 34 of the secondary frame 28 substantially aligns with the nose bridge 20 of the primary frame 12.

The magnets 44, 46 according to one embodiment may be shaped as a slightly curved plate following the curvature of the nose bridge 20, and may be embedded for example in the nose bridge 20 of the primary frame 12 and in the connector 38 of the secondary frame 28, respectively, during molding formation processes of the respective nose bridge 20 and connector 38. The magnet 46 may also be located in the nose bridge 34 because the nose bridge 34 is an integral part of the connector 38 according to this embodiment. The magnets 44 and 46 may be substantially vertically positioned such that polarity orientations of the magnets 44, 46 indicated by respective lines 52, 54 (see FIG. 6), are substantially normal to the respective primary lenses 18 and the secondary lenses 32 (or the respective planes defined by the primary lenses 18 and the secondary lenses 32).

Optionally, the positioning member 40 of the connector 38 according to one embodiment, may be configured to be fitted into the recess 42 of the nose bridge 20 in order to allow the magnet 46 affixed to the connector 38 and the magnet 44 affixed to the nose bridge 20 of the primary frame 12, to be aligned one with the other, thereby creating maximum magnetic forces interacting therebetween for a secure attachment of the clip-on lens assembly 26 to the primary frame 12 of the eyewear 10.

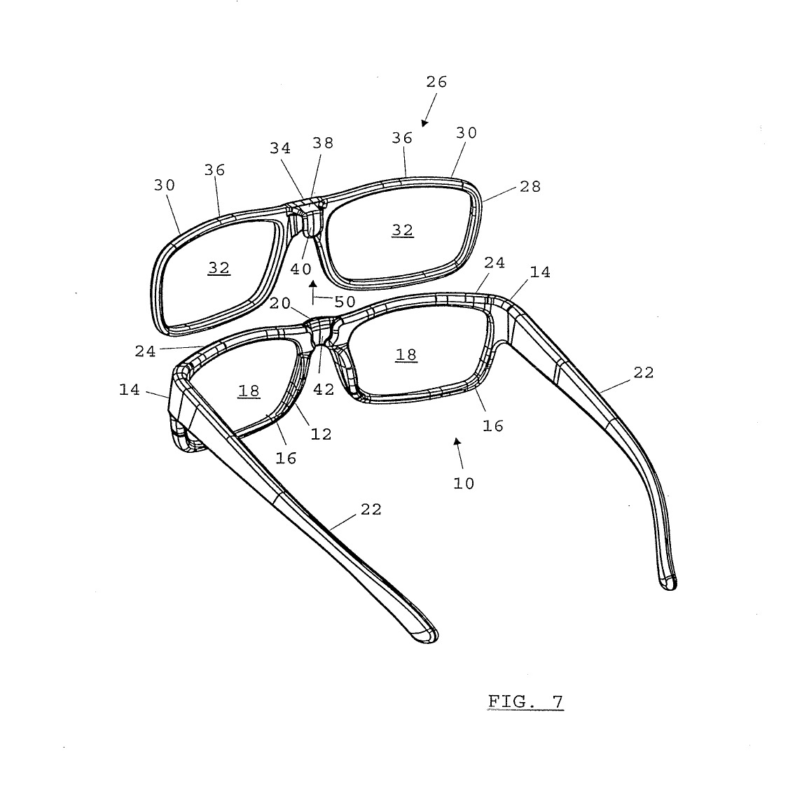

Alternatively, the positioning member 40 of the connector 38 according to another embodiment, may be configured to be fitted into the recess 42 such that the magnet 46 affixed to the connector 38 and the magnet 44 affixed to the nose bridge 20 of the primary frame 12, are placed within a magnetic force interaction area therebetween but are not perfectly aligned. The magnet 44 according to one embodiment, may be positioned slightly lower relative to the position of the magnet 46, as shown in FIG. 6. In such a magnet position arrangement, because the magnets 44, 46, are not perfectly aligned, the magnetic forces interacting between the magnets 44, 46 tend to pull the magnet 46 downwardly toward alignment with the magnet 44. This downward magnetic force as shown by arrow 48, advantageously secures the clip-on lens assembly 26 in position, against a potential pulling up motion (indicated by arrow 50 in FIG. 7) when the clip-on lens assembly 26 is being detached from the front of the primary frame 12.

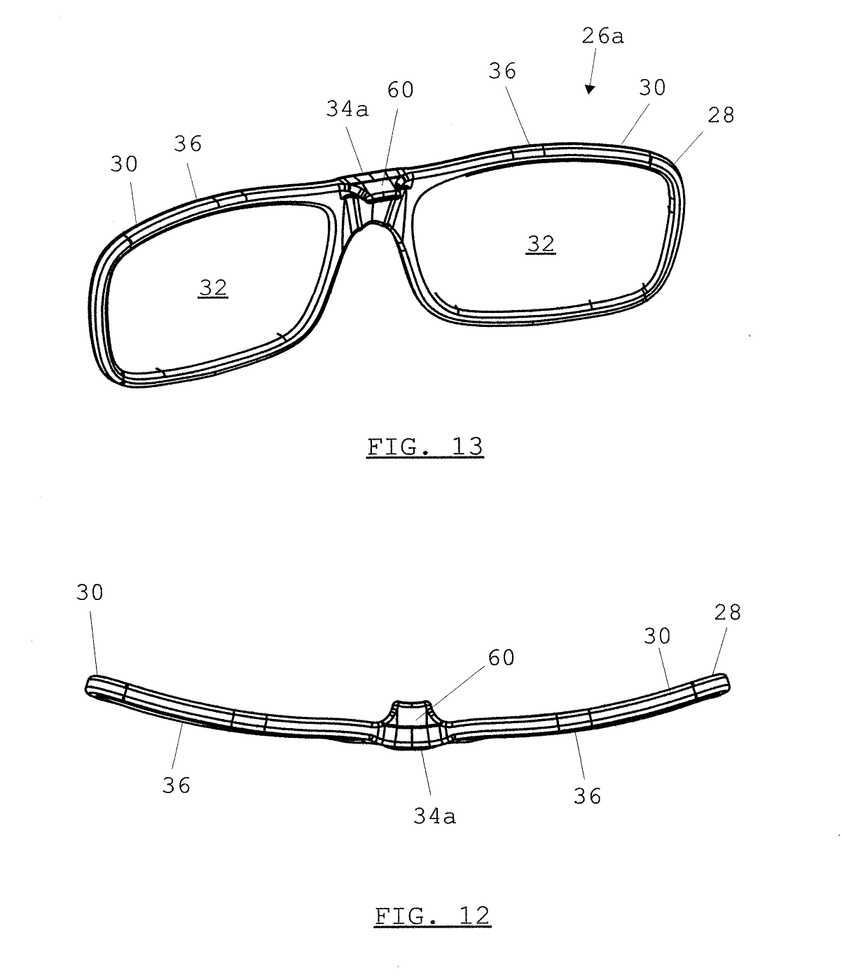

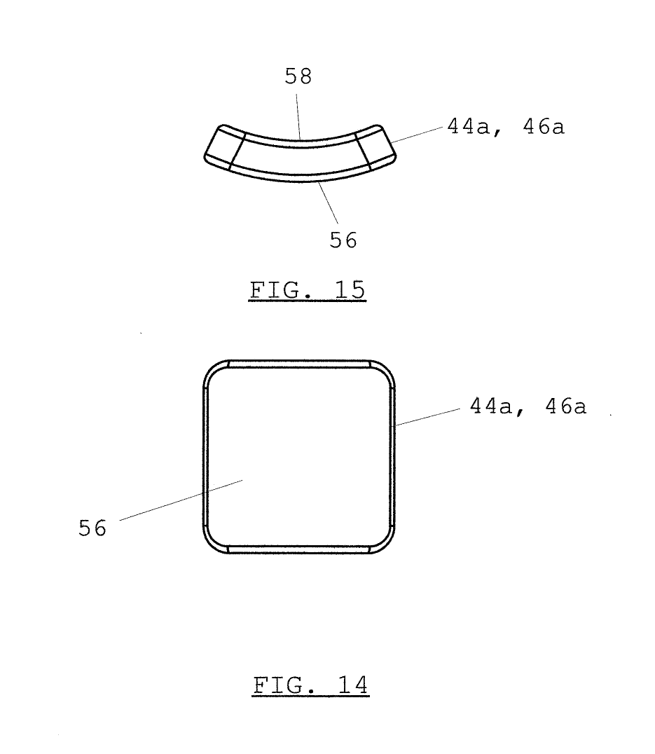

Referring to FIGS. 8-15, eyewear 10a is described according to another embodiment, and generally includes a primary frame 12a and a clip-on lens assembly 26a (secondary lens assembly), which are similar to the primary frame 12 and clip-on lens assembly 26 described with reference to FIGS. 1-7. Similar features are indicated by similar numerals and will not be redundantly described. The description of eyewear 10a will be focussed on the difference between eyewear 10a and eyewear 10.

The primary frame 12a according to this embodiment may be substantially similar to the primary frame 12 of the eyewear 10 as described with reference to FIGS. 1-7, except the nose bridge. The nose bridge 20a of the primary frame 12a may have a curved profile, at least defining a convex outer surface 21 (see FIG. 10), projecting away from the user's head when eyewear 10a is worn by the user (i.e. in the forward direction of the eyewear). The convex outer surface 21 of the nose bridge 20a extends vertically across the nose bridge 20a. A magnet 44a may be included to the nose bridge 20a, for example, being embedded in the nose bridge 20a during a plastic formation molding process of the primary frame 12a. The magnet 44a may be embedded completely in the nose bridge 20a and may not be visible.

The magnet 44a may also have a curved profile, to define a convex surface 56 and a concave surface 58 at opposite sides thereof such that the magnet 44a looks like a longitudinal section of a cylinder. The magnet 44a may be embedded in the nose bridge 20a such that the convex surface 56 of magnet 44a is oriented in accordance with the convex outer surface 21 of the nose bridge 20a.

The clip-on lens assembly 26a according to this embodiment may be substantially similar to the clip-on lens assembly 26 of eyewear 10 described with reference to FIGS. 1-7, except that instead of a hook-shaped connector 38 affixed to the nose bridge 34 of the secondary frame 26 described with reference to FIGS. 1-7, a positioning member 60 is provided which for example may be affixed to a central section of the upper part 36 of the secondary frame 28, such as a nose bridge 34a of the secondary frame 28 of the magnetic clip-on lens assembly 12a.

The nose bridge 34a of the secondary frame 28 of the clip-on lens assembly 26a may have a curved profile to define at least a concave inner surface 35 extending vertically across the nose bridge 34a. The concave inner surface 35 may share a common curvature with the convex outer surface 21 of the nose bridge 20a of the primary frame 12a. Therefore, the concave inner surface 35 and the convex outer surface 21 can mate with each other. The nose bridge 34a may include a magnet 46a which may be completely embedded in the nose bridge 34a during a plastic formation molding process of the nose bridge 34a.

The magnet 46a may have a curved profile similar to the curved profile of the magnet 44a, defining convex outer surface 56 and concave inner surface 58 at opposite sides thereof (see FIG. 15). The magnet 46a may be placed such that the concave surface 58 of the magnet 46a is oriented in accordance with the concave inner surface 35 of the nose bridge 34a. Optionally, the magnet 46a may be completely embedded in the nose bridge 34a, or may be partially embedded in the nose bridge 34a to expose the concave surface 58 thereof such that the concave surface 58 of the magnet 46a forms part of the inner concave surface 35 of the nose bridge 34a of the secondary frame 28.

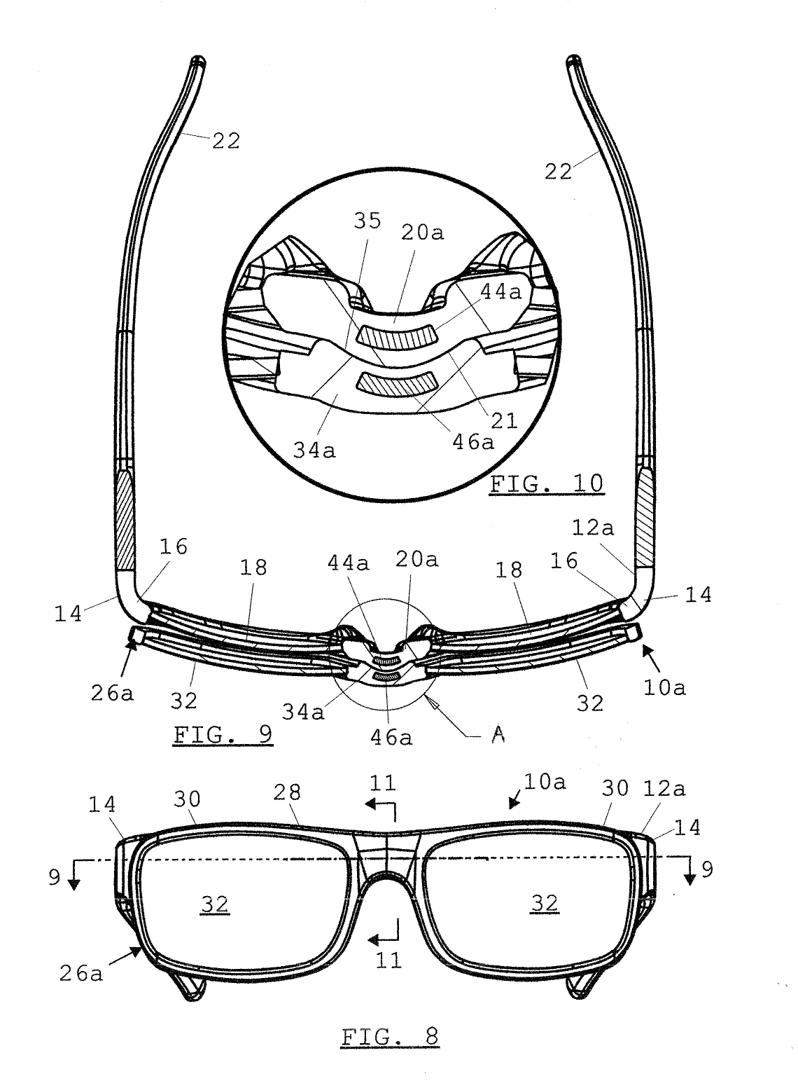

The positioning member 60 according to this embodiment, may be affixed to or integrated with the nose bridge 34a, projecting toward the user's head (in a rearward direction of the eyewear) extending over and being in contact with the nose bridge 20a of the primary frame 12a when the nose bridge 34a of the secondary frame 28 is removably attached to the nose bridge 20a of the primary frame 12a by magnetic forces interacting between the magnets 44a, 46a to cause the concave inner surface 35 of the nose bridge 34a to mate with the convex outer surface 21 of the nose bridge 20a of the primary frame 12a, as illustrated in FIGS. 9 and 10. The positioning member 60 positions the clip-on lens assembly 26a relative to the primary frame 12a such that the magnets 44a and 46a are placed within a magnetic interaction area between the magnets 44a and 46a, with the magnet 44a positioned lower than the magnet 46a, in order to create a downward magnetic force as indicated by arrow 48, the advantage of which was discussed in the description of eyewear 10 and will not be repeated herein.

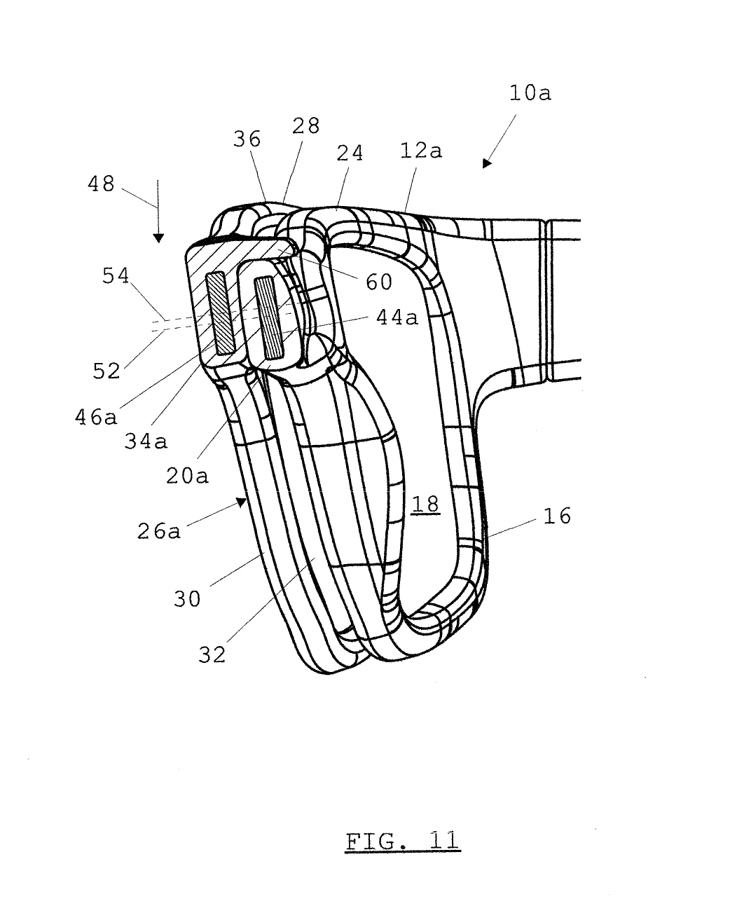

The attachment of the clip-on lenses assembly 26a to the primary frame 10a achieved between the mating convex outer surface 21 of the nose bridge 20a and concave inner surface 35 of the nose bridge 34a advantageously prevents rotational movement of the clip-on lenses assembly 26a with respect to the primary frame 12a of eyewear 10a. Similar to the magnets 44 and 46 in eyewear 10 described with reference to FIGS. 1-7, polarity orientations of the magnets 44a and 46a indicated by respective lines 52, 54 (see FIG. 11) are substantially normal to the respective primary lenses 18 and the secondary lenses 32 (or the respective planes defined by the primary lenses 18 and the secondary lenses 32).

Alternatively, when the eyewear and the corresponding clip-on eyewear assembly each have a unitary lens without the respective nose bridges, the magnets, connector, positioning member and/or recess as described in the above embodiments, may be positioned in a central section of an upper part of the respective primary, and secondary frames.

The above description is meant to be exemplary only, and one skilled in the art will recognize that changes may be made to the embodiments described without departing from the scope of the described subject matter. The eyewear may be configured in various styles different from what is illustrated in the drawings. Modifications which fall within the scope of the described subject matter will be apparent to those skilled in the art, in light of a review of this disclosure, and such modifications are intended to fall within the appended claims.

1. Eyewear comprising:
a primary frame retaining at least one primary lens, the primary frame having an upper part extending between opposed side ends of the primary frame and a support device being operatively attached to the respective opposed side ends of the primary frame for supporting the eyewear on a user's head, and a first magnet attached to a first central section of the upper part, the first central section having a convex outer surface projecting away from the user's head; and
a secondary lens assembly removably attachable to a front of the primary frame, the secondary lens assembly including:
a secondary frame retaining at least one secondary lens, the secondary frame having an upper part extending between opposed side ends of the secondary frame, a second central section of the upper part of the secondary frame defining a concave inner surface and including a second magnet to allow the second central section of the upper part of the secondary frame to be removably attached to the first central section of the upper part of the primary frame by magnetic forces interacting between the first and second magnets, the concave inner surface of the second central section of the upper part of the secondary frame mating with the convex outer surface of the first central section of the upper part of the primary frame.

2. The eyewear as defined in claim 1 wherein the second central section of the upper part of the secondary frame comprises a positioning member projecting over and being in contact with the first central section of the upper part of the primary frame when attached thereto such that the first and second magnets are placed within a magnetic interaction area between the first and second magnets, the first magnet being positioned lower than the second magnet.

3. The eyewear as defined in claim 1 wherein a polarity orientation of the first magnet is in a line substantial normal to the at least one primary lens, and wherein a polarity orientation of the second magnet is in a line substantial normal to the at least one secondary lens.

4. The eyewear as defined in claim 1 wherein the first magnet comprises a convex surface oriented in accordance with the convex outer surface of the central section of the upper part of the primary frame, and wherein the second magnet comprises a concave surface oriented in accordance with the concave inner surface of the second central section of the upper part of the secondary frame.

5. The eyewear as defined in claim 1 wherein the second magnet is completely embedded in the second central section of the upper part of the secondary frame.

6. The eyewear as defined in claim 1 wherein the second magnet is partially embedded in the second central section of the upper part of the secondary frame to expose the concave surface of the second magnet such that the concave surface of the second magnet forms part of the inner concave surface of the second central section.

7. Eyewear comprising:
a primary frame having opposed side ends and including primary left and right sections retaining a pair of primary lenses, respectively, a first nose bridge being disposed between and interconnecting the primary left and right sections, a support device being operatively attached to the respective opposed side ends of the primary frame for supporting the eyeglasses on a user's head, the first nose bridge including a first magnet and defining a convex outer surface projecting away from the user's head; and
a secondary lens assembly removably attached to a front of the primary frame, the secondary lens assembly including:
a secondary frame including secondary left and right sections retaining a pair of secondary lenses, respectively, a second nose bridge being disposed between and interconnecting the secondary left and right sections, the second nose bridge defining a concave inner surface and including a second magnet to allow the second nose bridge to be removably attached to the first nose bridge of the primary frame by magnetic forces interacting between the first and second magnets, the concave inner surface of the second nose bridge mating the convex outer surface of the first nose bridge; and
a positioning member affixed to the second nose bridge of the secondary frame, projecting over and being in contact with the first nose bridge such that the first and second magnets are placed within a magnetic interaction area between the first and second magnets, the first magnet being positioned lower than the second magnet.

8. The eyewear as defined in claim 7 wherein the first magnet comprises a convex surface oriented in accordance with the convex outer surface of the nose bridge of the primary frame, and wherein the second magnet comprises a concave surface oriented in accordance with the concave inner surface of the second nose bridge of the secondary lens assembly.

9. The eyewear as defined in claim 7 wherein the second magnet is partially embedded in the second nose bridge to expose the concave surface thereof such that the concave surface of the second magnet forms part of the inner concave surface of the second nose bridge.

10. The eyewear as defined in claim 7 wherein the first magnet is positioned to have a polarity orientation thereof in a first line substantially normal to the primary lenses and wherein the second magnet is positioned to have a polarity orientation thereof in a second line substantially normal to the secondary lenses.

11. The eyewear as defined in claim 7 wherein the convex outer surface of the first nose bridge and concave inner surface of the second nose bridge substantially vertically extend cross the respective first and second nose bridges.
